(19) United States
(12) Patent Application Publication
(10) Pub. No.: US 2022/0315261 A1
(43) Pub. Date: Oct. 6, 2022

(54) REDUCED PLASTIC SONICALLY WELDABLE FRESH PRODUCE PACKAGING LID

(71) Applicant: Braga Fresh Foods, LLC, Spreckets, CA (US)

(72) Inventors: Nicholas Joseph DaCosta, Carmel, CA (US); Emmanuel Capulin, Spreckels, CA (US); Michael Robert Hattrup, JR., El Centro, CA (US)

(73) Assignee: Braga Fresh Foods, LLC, Spreckels, CA (US)

(21) Appl. No.: 17/713,477

(22) Filed: Apr. 5, 2022

Related U.S. Application Data
(60) Provisional application No. 63/170,731, filed on Apr. 5, 2021.

(51) Int. Cl. B65B 51/10; B65D 6/00; B65D 43/02; B65D 51/24; B65B 61/26; B29C 65/08; B29C 65/00

(52) U.S. Cl. CPC B65B 51/10; B65D 11/10; B65D 43/0218; B65D 51/245; B65B 61/26; B29C 65/08; B29C 66/21; B65D 2203/02; B65D 2543/00101; B65D 2543/00194; B65D 2543/0024; B65D 2543/00296; B65D 2543/00425; B65D 2543/00629; B65D 2543/00685

(57) ABSTRACT

The semirigid plastic content of a fresh produce container is reduced by omitting or removing a central portion of a semirigid plastic lid to form a central opening therein. The central opening is covered and sealed by a plastic film, which can be applied before, during, or after packaging. The film can include visible indicia. The plastic film can be attached to an inner flange of the lid that surrounds the central opening, and can be by a resealable adhesive. During a packaging step, the tray is filled with the fresh produce, and then the lid can be sonically spotwelded to the tray. The sonic spotwelding can be of an outer lid flange to a corresponding outer tray flange. In embodiments where the central portion of the lid is removed, the removed plastic can be combined with precursor plastic and used to form additional semirigid plastic lids.

### RELATED APPLICATIONS

This application claims the benefit of U.S. Provisional Application No. 63/170,731, filed Apr. 5, 2021, which is herein incorporated by reference in its entirety for all purposes.

### FIELD OF THE INVENTION

The invention relates to packaging of fresh produce, and more particularly, to fresh produce packaging having a reduced content of semirigid plastic.

### BACKGROUND OF THE INVENTION

It is important that fresh produce be packaged rapidly, both to maintain the freshness of the produce, and also to reduce the packaging cost. With reference to FIGS. 1A-1C, the packaging process is often performed in a single operation, and includes depositing the fresh produce into a semi-rigid plastic tray 100 (FIG. 1A), placing a semi-rigid plastic lid 102 onto the tray 100 (FIG. 1B), and then fixing the lid 102 to the tray 100 using sonic spotwelding 106 (FIG. 1C). The tray may include an upper rim 116 surrounded by a tray flange 110 that can be sonic spotwelded to a corresponding lid flange 112 provided on the lid 102. The lid 102 may also include a raised recess 114 into which the rim 116 of the tray 100 is inserted when the lid 102 is installed on the tray 100. It is common for a label 104 to be attached to the lid 102 in a separate step before the fresh produce is packaged, so that the adhesive label attachment does not cause any additional delay to the packaging process. Or, product identification may be printed directly onto the lid 102.

The use of sonic spotwelding 106 to attach the lid 102 to the tray 100 is highly desirable in some cases, because sonic spotwelding attachment 106 does not require use of an adhesive, and can be completed very rapidly. Also, attachment by sonic spotwelding 106 does not provide an air-tight seal, but instead provides ventilation between the interior of the package and the exterior environment, which is highly desirable for many types of fresh produce.

There is, however, a growing desire among many consumers to minimize the impact of their purchases on the environment. While many plastics can be recycled, consumers are aware that recycled plastic can only be used in a limited number of applications, due to the mixing of many different types of plastic in a “load” of recycled plastic articles, and due to paper labels, inks, and other contaminants that are typically present in a load of recycled articles. Plastics can also be incinerated, but only at the expense of energy and with consequent release of greenhouse gasses.

The use of plastic for packaging is therefore considered by many consumers to have a direct, negative effect on the environment, and for that reason there is a growing demand to reduce the quantity of plastic that is incorporated into packages.

One approach is to package fresh produce in a film bag. However, this approach is not ideal for product that is easily damaged by crushing. In such cases, a semi-rigid or rigid tray is required.

With reference to FIG. 1D, another approach to reducing the amount of plastic included in a package is to apply a film lid 108 to a semi-rigid tray instead of using a semi-rigid plastic lid 102. However, this approach is not desirable for packaging of certain types of fresh produce, because the adhesive attachment of the film lid 108 to the tray 118 is a much slower process than sonic spotwelding 106, and because an adhesively attached film lid 108 tends to provide an airtight seal with the tray 118, thereby reducing the ventilation of the package interior.

What is needed, therefore, is a packaging solution that provides rapid, ventilated packaging of fresh produce while reducing the quantity of plastic that is included in the container.

### SUMMARY OF THE INVENTION

The present invention is a packaging solution that provides rapid, ventilated packaging of fresh produce while reducing the quantity of plastic that is included in the container. A semirigid plastic tray and a semi-rigid plastic lid are prepared, similar to the tray 100 and lid 102 of FIGS. 1A-1C. However, unlike FIGS. 1A-1C, the lid of the present invention is prepared with a large opening in the center thereof. As such, the semi-rigid lid of the present invention is essentially an attachment flange that surrounds a large central opening. This approach significantly reduces the amount of plastic that is included in the lid.

In embodiments, the semirigid lid is either manufactured with the large central opening already present, or a traditional semirigid plastic lid is prepared, as shown in FIG. 1A-1C, and then a large central region is cut out of the lid and recycled. Recycling of the lid cut-outs in embodiments is highly efficient and does not damage the environment, because the cut-outs are known to be clean, free of contaminants, and all of the same type of plastic, thereby enabling their full re-use to make additional lids, without discarding any of the cutouts.

The present invention further includes preparing a film label and adhered the film label to the semi-rigid plastic lid so that the film label covers and seals the large central opening in the lid. In embodiments, the film label is applied using an adhesive. Depending on the embodiment, the film label can be applied to the lid during a separate, pre-packaging step, during the packaging process (e.g. immediately after the fresh produce is deposited in the semi-rigid plastic tray, or in a post-packaging step. It will be understood that while the “film label” may include visible markings such as a product name, description and/or image, nevertheless the term “film label” is used herein to refer to any film that can be applied to the semirigid plastic lid so that it covers and seals the large central opening in the lid, whether or not the film includes an actual “label,” or other visible markings.

Because the assembled semirigid lid and film label are applied to the filled, semi-rigid tray using sonic spotwelding, according to known methods, embodiments of the present invention do not require any modification of the primary packaging apparatus or method. In embodiments where the film label is applied to the semi-rigid tray in a separate, pre-packaging step, the speed at which produce can be packaged is not retarded by the film application. Instead, in these embodiments the only added requirement, which is not time sensitive, is the application of the film labels to the semirigid plastic lids before they are transferred to the packaging apparatus.

One general aspect of the present invention is a lid assembly having reduced plastic, the lid assembly being suitable for sonic spotwelding to a compatible tray. The lid assembly includes a semirigid plastic lid, a central opening provided in the semirigid plastic lid, and a film label applied to the lid so as to cover and seal the central opening.

In embodiments, the film label is adhered to the semirigid plastic lid by an adhesive.

In any of the above embodiments, the semirigid plastic lid can include an outer lid flange that can be sonically spotwelded to an outer tray flange of the compatible tray.

Any of the above embodiments can further include an inner lid flange surrounding the central opening. In some of these embodiments the film label is applied to the inner flange.

In any of the above embodiments, the lid can further includes a raised recess configured to be installed over an upper rim of the compatible tray.

A second general aspect of the present invention is a method of packaging fresh produce. The method includes preparing a semirigid plastic lid and a film label according to claim 1, forming a lid assembly by applying the film label to the lid so that the film label covers and seals the central opening, preparing a tray that is compatible with the lid, filling the tray with the fresh produce, and attaching the lid to the tray.

In embodiments, the step of forming the lid assembly precedes the step of attaching the lid to the tray, or the film label is applied to the lid after the step of attaching the lid to the tray.

In any of the above embodiments, attaching the lid assembly to the tray can include sonic spotwelding the lid assembly to the tray. In some of these embodiments the semirigid plastic lid further comprises an outer lid flange, and the compatible tray includes an outer tray flange, and wherein attaching the lid to the tray includes sonic spotwelding of the outer lid flange to the outer tray flange.

In any of the above embodiments, the semirigid plastic lid can further include an inner lid flange surrounding the central opening, and attaching the film label to the tray can include attaching the film label to the inner flange. In some of these embodiments, the film label is attached to the inner flange by an adhesive.

In any of the above embodiments, the film label can be attached to the semirigid plastic lid by a resealable adhesive that enables the film label to be peeled away from the semirigid plastic lid, and then resealed thereto.

In any of the above embodiments, preparing the film label can include applying visible indicia to the film label.

In any of the above embodiments, preparing the semirigid plastic lid can include forming a semirigid plastic lid that does not include a central opening, and then forming the central opening in the semirigid plastic lid by cutting out a central cut-out portion of the semirigid plastic lid. And in some of these embodiments the method further includes recycling the central cut-out portion by combining it with a supply of precursor plastic, and then forming at least one additional semirigid plastic lid from the precursor plastic.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is a perspective view of a lid positioned above a compatible tray for a fresh produce container of the prior art;

FIG. 1B is a perspective view of the container of FIG. 1A shown with the lid attached to the tray;

FIG. 1C is a top view of the container of FIG. 1B, showing sonic spotwelding of the lid to the tray;

FIG. 1D is a perspective view of a fresh produce tray covered and sealed by a plastic film according to the prior art;

FIG. 2A is a top view of a semirigid plastic lid having a central opening according to an embodiment of the present invention, where the figure also includes the removed portion of the semirigid plastic lid a film label prepared for adherence to the semirigid plastic lid so as to cover and seal the central opening;

FIG. 2B is a top view of the lid assembly of FIG. 2A, shown with that film label adhered to the semirigid plastic lid and thereby covering and sealing the central opening;

FIG. 2C is a rear view of the lid assembly of FIG. 2B, showing adhesive attachment of the film label to an inner flange of the semirigid plastic lid according to an embodiment of the present invention;

FIG. 3 is a top view of the lid assembly of FIG. 2B, showing an outer flange of the lid sonically spotwelded to a corresponding outer flange of an underlying tray;

FIG. 4 is a perspective view of an assembled lid and tray according to an embodiment of the present invention wherein the film label can be peeled back and then re-sealed to the semi-rigid plastic lid; and

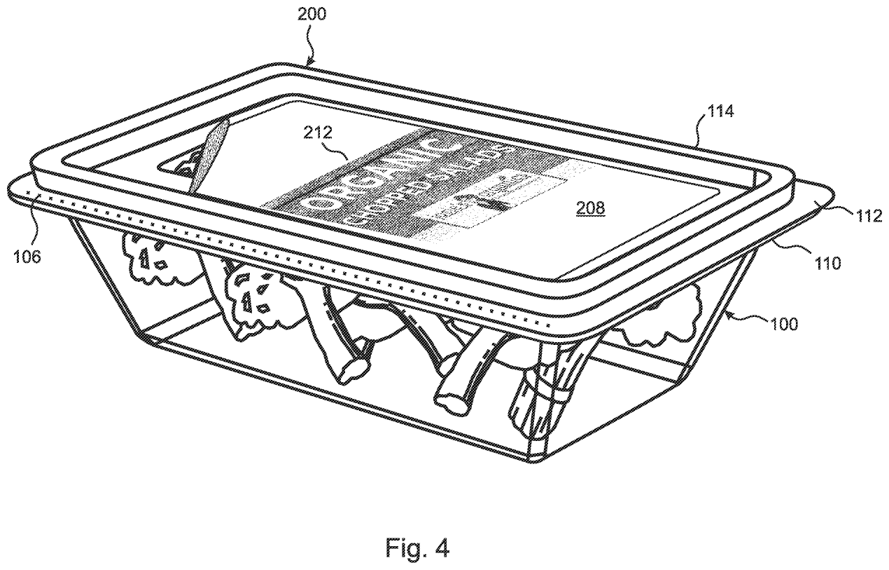

FIG. 5 is a flow diagram that illustrates a method embodiment of the present invention.

### DETAILED DESCRIPTION

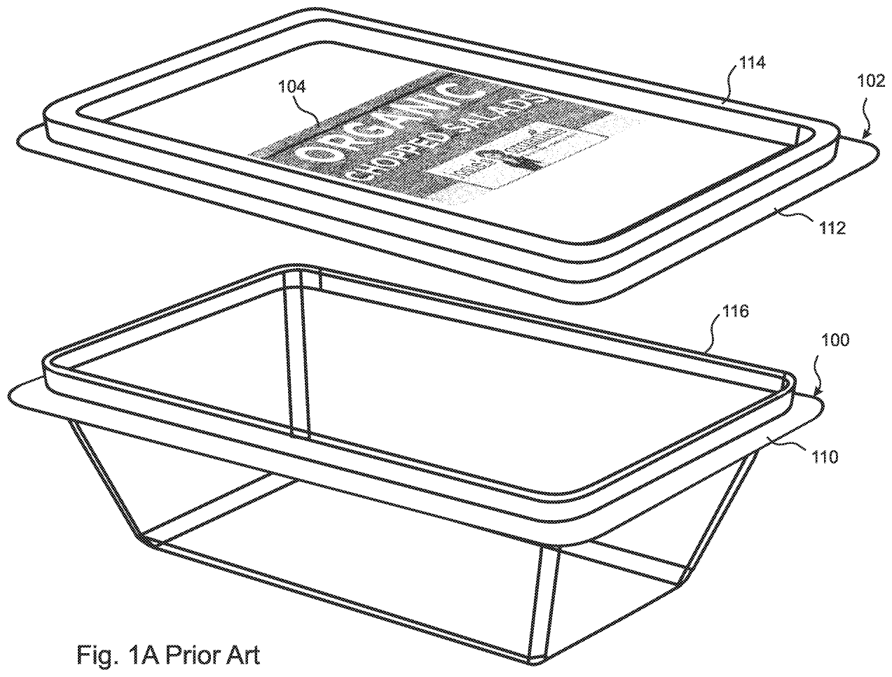

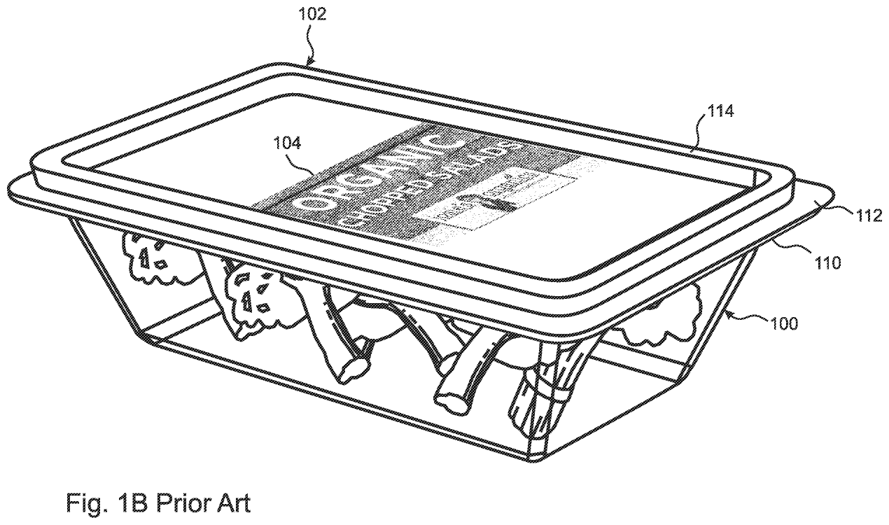

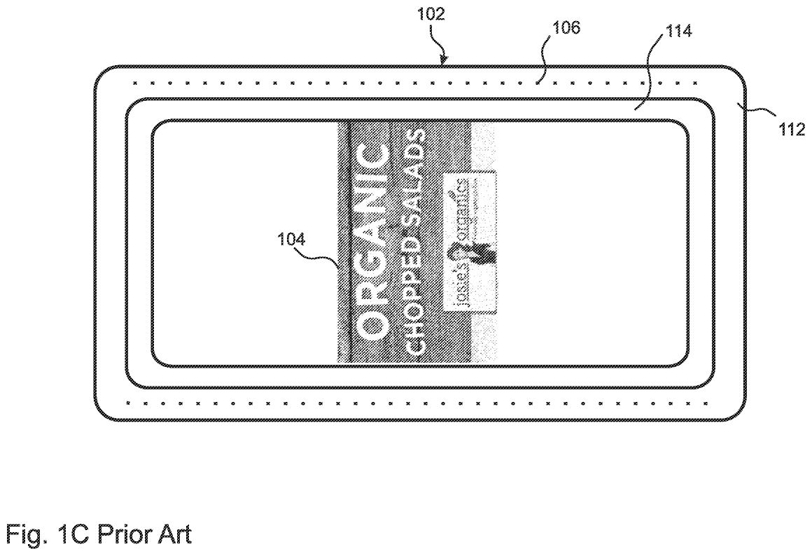

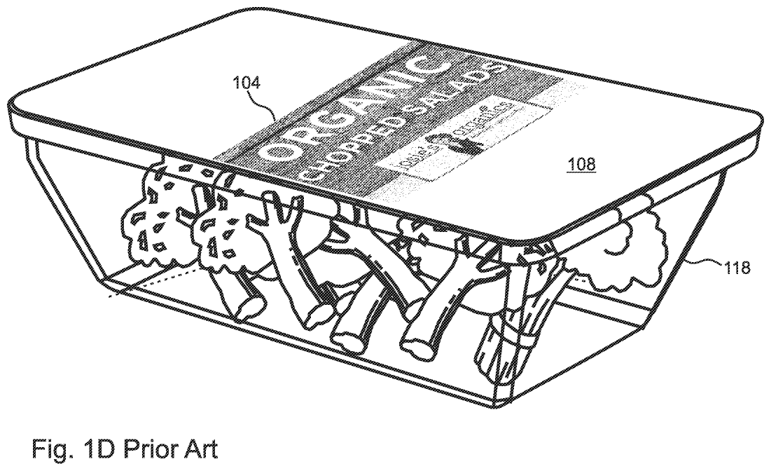

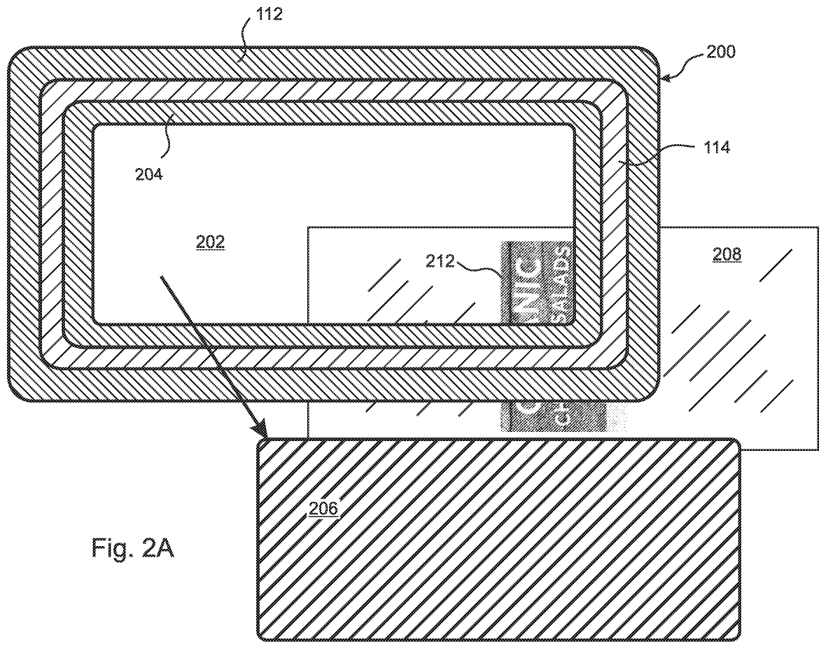

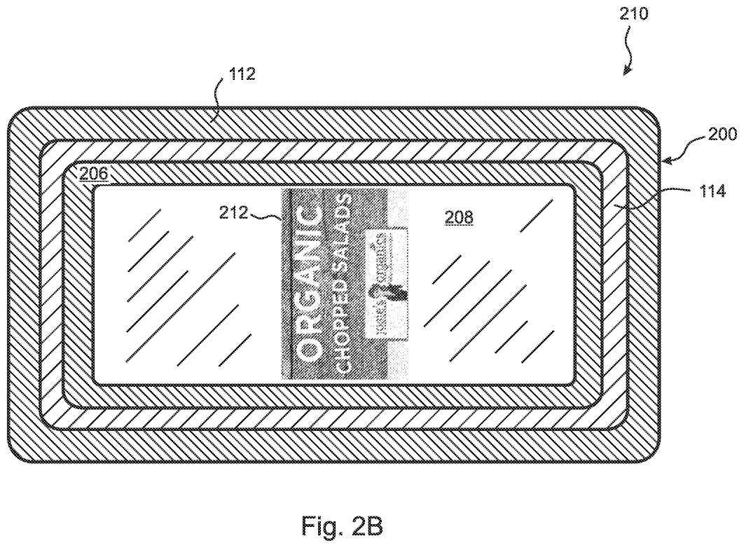

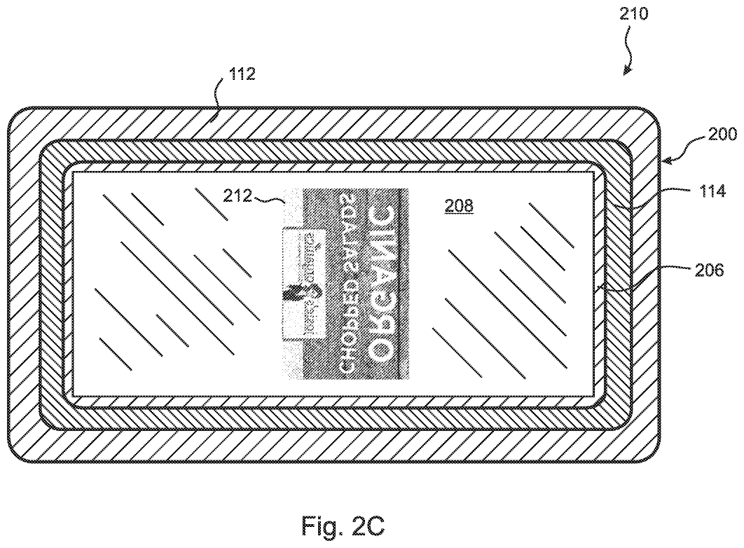

The present invention is a packaging solution that provides rapid, ventilated packaging of fresh produce, while reducing the quantity of plastic that is included in the container. With reference to FIG. 2A, a semirigid plastic tray 100 and a semi-rigid plastic lid 200 are prepared, similar to the tray 100 and lid 102 of FIGS. 1A-1C. However, unlike FIGS. 1A-1C, the lid 200 of the present invention is prepared with a large opening 202 in the center thereof. As such, the semi-rigid lid 200 of the present invention is essentially an attachment flange that surrounds a large central opening 202. This approach significantly reduces the amount of semi-rigid plastic that is included in the lid.

In the embodiment of FIG. 2A, the semirigid plastic lid 200 includes an outer flange 112 that is suitable for spotwelding to a corresponding flange 110 of the tray. The semirigid plastic lid 200 also includes a raised recess 114 into which the rim 116 of the tray 100 can be inserted. The semirigid plastic lid 200 further includes an inner flange 204 that extends inward from the raised recess 114 and surrounds the large central opening 202.

In embodiments, the semirigid lid 200 is either manufactured with the large central opening 202 already present, or a traditional semirigid plastic lid is prepared, similar to the lid 102 that is illustrated for example in FIGS. 1A-1C, and then a large central region 206 is cut out of the lid 200, thereby forming the large central opening 202 in the lid 200. The lid cut-outs 206 are known to be free of contaminants and to be all of the same type of plastic, thereby enabling their full re-use to make additional lids 200, without discarding any of the cutouts 206.

The present invention further includes preparing a film “label” 208 and adhering the film label 208 to the semi-rigid plastic lid 200, as illustrated in FIG. 2B, so that the film label 208 covers and seals the large central opening 202 in the lid 200. In embodiments, the film label 208 includes visible indicia 212, for example text and/or images that identify the contents and the source of the goods. In embodiments, the film label 208 is applied to the lid 200 using an adhesive during a separate, pre-packaging step. In other embodiments, the film label 208 is applied to the lid 200 during the packaging process, or as a post-packaging step. In the embodiment of FIG. 2B, the film label 208 is applied to the lid 200 in a pre-packaging step, and extends over and is adhered to the inner flange 206 of the semirigid lid 200 from behind. The inner flange 206 is therefore visible in the front view of FIG. 2B, but is largely covered by the film label 208 in the rear view of FIG. 2C. In other embodiments, the film label 208 is adhered to the lid 200 from in front of the lid 200, for example in a post-packaging application of the film label 208.

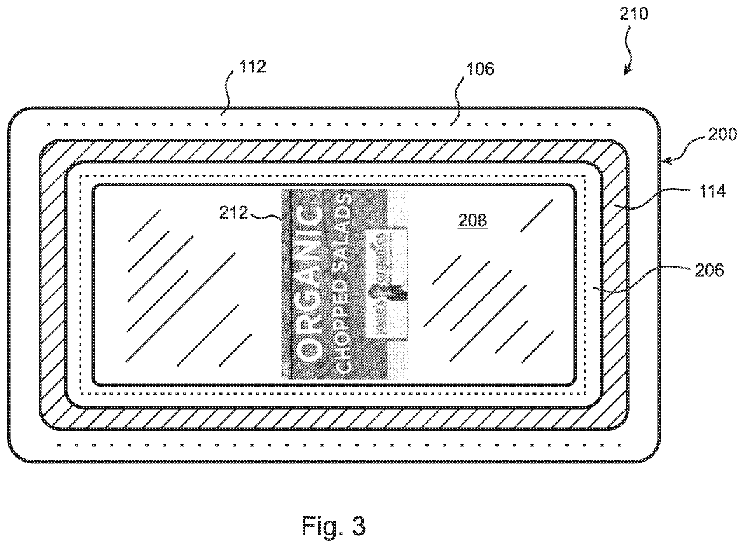

With reference to FIG. 3, in the illustrated embodiment the semirigid lid and film label assembly 210 are then applied to the produce-filled tray 100 using sonic spotwelding 106, according to known methods. Embodiments of the present invention therefore do not require any modification of the primary packaging apparatus or method, and do not retard the speed at which produce can be packaged. Instead, the only added requirement in these embodiments, which is not time sensitive, is the application of the film labels 208 to the semirigid 200 plastic lids before they are transferred to the packaging apparatus.

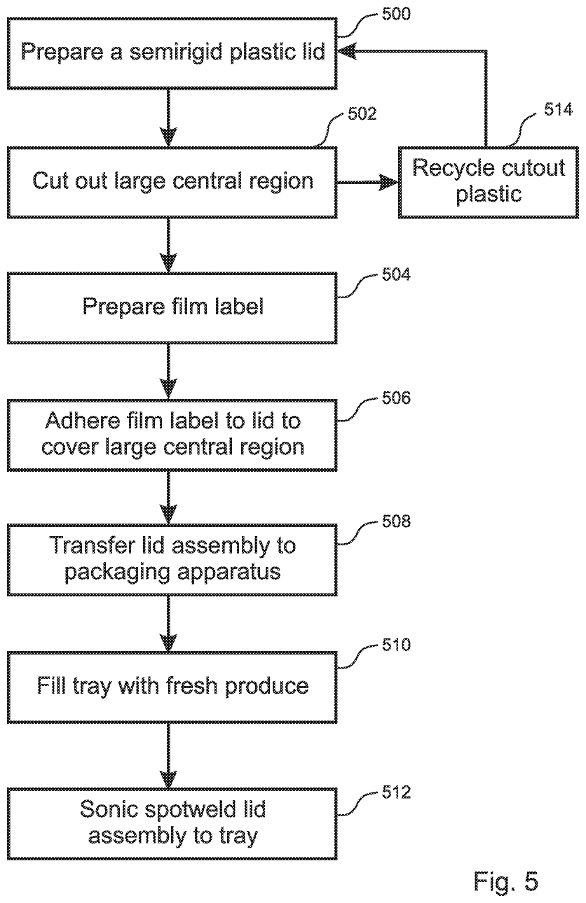

FIG. 5 is a perspective view of an assembled lid 200 and tray after filling of the tray with fresh produce and applying the film label 208 to the lid 200, where the film label 208 in this embodiment is applied to the lid 200 after the tray 100 has been filled with the fresh produce. In the illustrated embodiment, the film label 208 is applied using an adhesive that allows the film label 208 to be peeled back from the semi-rigid lid 200, as shown in the figure, and then resealed to the lid 200 after some, but not all, of the fresh produce has been removed.

A method of packaging fresh produce according to an embodiment of the present invention includes preparing 500 a semirigid plastic lid 200, cutting out 502 a large central region 206 of the lid 200, thereby creating a large central opening 202 in the lid 200, preparing 504 a film label 208, and adhering 506 the film label 208 to the semirigid plastic lid 200, so that the film label 208 covers and seals the large central opening 202. The resulting lid assembly 210 is then transferred 508 to a packaging apparatus, in which a tray 100 is filled 510 with the fresh produce, and then the lid assembly 210 is applied and sonically spotwelded 512 to the tray 100. Meanwhile, the lid cutout 216 is recycled 514 into the manufacturing 500 of more lids 202.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

Although the present application is shown in a limited number of forms, the scope of the invention is not limited to just these forms, but is amenable to various changes and modifications. The disclosure presented herein does not explicitly disclose all possible combinations of features that fall within the scope of the invention. The features disclosed herein for the various embodiments can generally be interchanged and combined into any combinations that are not self-contradictory without departing from the scope of the invention. In particular, the limitations presented in dependent claims below can be combined with their corresponding independent claims in any number and in any order without departing from the scope of this disclosure, unless the dependent claims are logically incompatible with each other.

I claim:

1. A lid assembly having reduced plastic, the lid assembly being suitable for sonic spotwelding to a compatible tray, the lid assembly comprising:
a semirigid plastic lid;
a central opening provided in the semirigid plastic lid; and
a film label applied to the lid so as to cover and seal the central opening.

2. The lid assembly of claim 1, wherein the film label is adhered to the semirigid plastic lid by an adhesive.

3. The lid assembly of claim 1, wherein the semirigid plastic lid includes an outer lid flange that can be sonically spotwelded to an outer tray flange of the compatible tray.

4. The lid assembly of claim 1, further comprising an inner lid flange surrounding the central opening.

5. The lid assembly of claim 4, wherein the film label is applied to the inner flange.

6. The lid assembly of claim 1, wherein the lid further includes a raised recess configured to be installed over an upper rim of the compatible tray.

7. A method of packaging fresh produce, the method including:
preparing a semirigid plastic lid and a film label according to claim 1;
forming a lid assembly by applying the film label to the lid so that the film label covers and seals the central opening;
preparing a tray that is compatible with the lid;
filling the tray with the fresh produce; and
attaching the lid to the tray.

8. The method of claim 7, wherein the step of forming the lid assembly precedes the step of attaching the lid to the tray.

9. The method of claim 7, wherein the film label is applied to the lid after the step of attaching the lid to the tray.

10. The method of claim 7, wherein attaching the lid assembly to the tray comprises sonic spotwelding the lid assembly to the tray.

11. The method of claim 10, wherein the semirigid plastic lid further comprises an outer lid flange, and the compatible tray includes an outer tray flange, and wherein attaching the lid to the tray includes sonic spotwelding of the outer lid flange to the outer tray flange.

12. The method of claim 7, wherein the semirigid plastic lid further includes an inner lid flange surrounding the central opening, and wherein attaching the film label to the tray includes attaching the film label to the inner flange.

13. The method of claim 12, wherein the film label is attached to the inner flange by an adhesive.

14. The method of claim 7, wherein the film label is attached to the semirigid plastic lid by a resealable adhesive that enables the film label to be peeled away from the semirigid plastic lid, and then resealed thereto.

15. The method of claim 7, wherein preparing the film label includes applying visible indicia to the film label.

16. The method of claim 7, wherein preparing the semirigid plastic lid includes forming a semirigid plastic lid that does not include a central opening, and then forming the central opening in the semirigid plastic lid by cutting out a central cut-out portion of the semirigid plastic lid.

17. The method of claim 16, wherein the method further includes recycling the central cut-out portion by combining it with a supply of precursor plastic, and then forming at least one additional semirigid plastic lid from the precursor plastic.
